(19) United States
(12) Patent Application Publication
(10) Pub. No.: US 2015/0016977 A1
(43) Pub. Date: Jan. 15, 2015

(54) ASSEMBLY OF A TURBOMACHINE

(71) Applicant: SIEMENS AKTIENGESELLSCHAFT, MÜNCHEN (DE)

(72) Inventors: Erich Muranyi, Duisburg (DE); Dieter Nass, Moers (DE); Gregor Senyk, Kempen (DE)

(73) Assignee: SIEMENS AKTIENGESELLSCHAFT, MUNCHEN (DE)

(21) Appl. No.: 14/378,101

(22) PCT Filed: Feb. 15, 2013
(86) PCT No.: PCT/EP2013/053106

§ 371 Date: Aug. 12, 2014

(30) Foreign Application Priority Data
Feb. 17, 2012 (DE) 102012202466.2

(51) Int. Cl. F04D 29/40; B23P 19/04

(52) U.S. Cl. CPC F04D 29/403; B23P 19/04
USPC 415/182.1; 29/889.2

(57) ABSTRACT

A turbomachine and a method for the assembly of the turbomachine with a housing and with a rotor, in which at least one cover of the housing is fastened to the rotor, and the combination is placed into a lower part of the housing and is then enclosed by an upper part of the housing, is provided. To attain centered mounting of the cover assembly and to thus prevent damage to the shaft seal, it is proposed that the combination, as it is placed in, is supported on at least one guide means in the housing, and the guide means forms a guide for the cover in the housing, by means of which guide the placed-in cover is held spaced apart from the housing lower part and the housing upper part with a radial assembly gap.

### CROSS-REFERENCE TO RELATED APPLICATIONS

This application claims priority to PCT Application No. PCT/EP2013/053106, having a filing date of Feb. 15, 2013, based off of DE 102012202466.2 having a filing date of Feb. 17, 2012, the entire contents of which are hereby incorporated by reference.

### FIELD OF TECHNOLOGY

The following relates to a method for assembling a turbomachine having a housing and a rotor, wherein at least one cover of the housing is fastened to the rotor, and this composite is inserted into a lower part of the housing and then enclosed by an upper part of the housing

### BACKGROUND

Turbomachines are used to expand or compress gases. Thus, in the case of a turbine, inlet gases are introduced into the turbine at high pressure and expand there, giving off energy to the rotor. Compressors, on the other hand, are used to compress air or other gases to final pressures of up to 100 bar or more. In this case, it is also possible for aggressive gases which are not intended to pass into the environment to be compressed. Accordingly, turbomachines should be sealed off such that the operating gases thereof cannot escape to the outside, or can escape to the outside only insignificantly, through the gaps between the shaft and the housing.

### SUMMARY

An aspect relates to a method for assembling a turbomachine, said method making sealed operation of the turbomachine easier.

Another aspect relates to a method of the type mentioned at the beginning, wherein, according to an embodiment, the composite is supported, during insertion, on at least one guide element in the housing and the guide element forms a guide for the cover in the housing, said guide keeping the inserted cover spaced apart from the upper housing part and lower housing part with a radial assembly gap. By maintaining the assembly gap, it is possible to ensure that a seal is not damaged during assembly, and so sealed operation of the turbomachine is allowed or at least rendered easier.

Embodiments of the invention is based on the consideration that turbomachines are supplied with gases, the temperature of which can deviate sometimes considerably from the housing temperature or ambient temperature of the turbomachine. Thus, for example, a turbine is supplied with a hot gas which expands in the turbine. Accordingly, some elements of the turbine are heated more by the hot gas than others. On the other hand, in the case of compressors, it is possible for extremely cold gases to be introduced and compressed, and so these gases cool the housing greatly at the location of the influx. Depending on the guiding of the operating gas through the turbomachine, different elements of the turbomachine cool at different rates. In the case of a compressor, cold gas reaches the housing and an inlet guide vane. These elements thus cool to a comparatively great extent. However, an axial cover of the housing cools relatively slowly compared with radially peripheral regions of the housing and so these regions of the housing contract more than the cover. The described elements do not reach the same temperature even during operation.

Embodiments of the invention are also based on the consideration that, for the purpose of sealing with respect to the rest of the housing, the cover is introduced into a fitting region of the housing, one or more seals being arranged in said fitting region. If the cover and housing rest radially against one another prior to operation, when the housing cools the contracting housing presses against the cover to a considerable extent radially from the outside. The joint between the lower housing part and upper housing part is pushed open with a corresponding force, and so leakages may possibly arise there. In order to avoid this pushing open of the housing joint, a radial gap of a few millimeters should remain between the cover and the housing, it being possible for said radial gap to be used for play when the housing contracts.

In large machines, the cover sealing can take place over two sealing stages, wherein the inner stage has a larger diameter than the outer stage. This embodiment makes it necessary to introduce the rotor together with the two covers as an assembly unit or as a composite into the lower part of the housing. If, during assembly, this composite is placed on the fitting region, which is somewhat wider on account of the gap, of the lower housing part, the cover and, together therewith, the shaft are not held in the housing in a centered manner. During the subsequent centering of the shaft in the housing, this can result in damage to the shaft seal, which is squashed downwardly in accordance with the gap dimensions.

In order to avoid this, the composite according to embodiments of the invention is already kept spaced apart from the upper housing part and lower housing part, in particular all the way round, with the radial assembly gap during assembly. The guide means ensures that the composite is supported in particular in a centered manner in the housing so that the radial assembly gap is maintained. As a result, the shaft mounted in the covers is also held in a centered manner in the housing such that during assembly the shipping insert, or during operation the shaft seal, is not squashed.

The composite is expediently set down on the guide means. Further expediently, as a result of the guiding by the guide means, the composite rests with less than 1% of its mass on a sealing surface of the composite, in particular of the cover, in particular with no weight.

As a result of the composite being set down on the guide means, vertical guiding of the cover in the housing can be achieved, such that the cover, or composite, does not have to be placed onto a fitting region of the lower housing part. The cover, or the composite, remains spaced apart from this fitting region by the width of a gap, for example of the assembly gap. The cover and, together therewith, the shaft can be held in a centered manner within the housing, so that damage to the shaft seal is avoided.

Embodiments of the invention has the particular advantage that the centered support of the composite already takes place during the assembly of the turbomachine and this support can also be maintained during operation, that is to say during the thermal movement of the housing relative to the cover, with the same guide means. Thus, although the composite is supported in the housing and has been placed on an element of the housing, it is held in the housing by the guide means such that it can always be held in a centered manner in the housing regardless of a thermal movement of the housing relative to the composite. Thus, it is possible to dispense with a separate assembly mount, for example in the fitting region, and thus also with an additional centering mount for centering the cover and the shaft during thermal movements during operation.

Since embodiments of the invention simplify not only assembly but also operation, and can make separate centering for operation superfluous, embodiments of the invention particularly advantageously also relates to a method for starting up the turbomachine and a method for the assembly thereof and for the operation thereof, such that the operation of the turbomachine can be included therein.

The turbomachine may be an expansion machine, such as a turbine, or a compressor, for example a turbocompressor, in particular, a single-shaft radial compressor. In addition to the cover and the rotor, the composite may contain further elements, for example, a flow guide vane, in particular, an inlet guide vane. The assembly gap is located expediently in the fitting region of the cover and the upper housing part and lower housing part, such that the cover and the housing parts are spaced apart from one another by the assembly gap in the fitting region. The width of the assembly gap is advantageously between 1 mm and 20 mm, in particular between 2 mm and 10 mm.

The guide means advantageously comprises one, in particular two guide elements on which the composite is set down. The guide elements expediently support the composite on the lower housing part. The guide elements are advantageously arranged in the housing such that the cover is located centrally between them. As a result of such symmetry, centered holding of the composite can be easily ensured. Expediently, the two guide elements are arranged at the level of the housing joint. In this way, height centering of the composite in the housing can be achieved without further compensation means.

The guide means can be fastened to the housing and/or to the composite. For example, the guide means comprises a formation on the composite such that the composite is placed on a corresponding bearing surface of the housing by way of this formation. Additionally or alternatively, it is possible for the housing to contain a formation into which a guide element of the composite is inserted. A bearing surface of the housing expediently comprises a depression into which a guide element or a formation of the guide means is inserted.

In addition to the vertical guiding of the composite, in particular the vertical centering thereof in the housing, it is advantageous for the composite also to be guided horizontally in the housing. To this end, in an advantageous embodiment of the invention, the composite forms a form fit with a guide element of the guide means during insertion, wherein this form fit forms a horizontal guide by way of which the cover or the composite is mounted in the housing in a horizontally guided manner. The horizontal guide can be unidimensional and be for example only a lateral guide. In particular, the horizontal guide is a guide transversely to the longitudinal axis of the rotor, wherein the direction in the longitudinal axis expediently remains unguided by the guide element.

The composite may for example be plugged onto the guide means, which engages into the composite from below. It is also possible for the guide element to be a formation of the composite, which is plugged into a corresponding recess in the housing. Expediently, the guide element is arranged beneath the two other guide elements of the guide means, in particular beneath the cover. In this way, guiding of the composite during insertion into the lower housing part is already achieved.

Further advantageously, the guide means is configured such that—in the event of thermal shrinkage of the housing relative to the cover—the cover slips in the guide and remains centered with respect to the housing. As a result of the slip-capable guiding, a movement of the cover relative to the housing or vice versa is easily achieved. The guide can in this case relate to the vertical guide of the guide means. Expediently, however, the cover slips in both guides, that is to say the vertical and the horizontal guide, such that, in the event of the thermal movement of the cover and housing relative to one another, it remains arranged in the housing in a two-dimensionally centered manner.

A further advantageous embodiment of the invention provides that, for the purpose of sealing, the cover is pulled axially outward in the housing against an axial seal and in the process slips in the guide. Such outwardly directed axial sealing is suitable particularly for large machines. As a result of the slippage of the cover in the guide in the case of such an axial movement for the purpose of sealing, the sealing can take placed particularly easily and quickly during the assembly process. In this case, the cover slips expediently in the vertical guide, in particular in both guides, so that it remains two-dimensionally centered.

Furthermore, embodiments of the invention are directed at a turbomachine having a rotor and a housing which has a lower housing part, at least one cover inserted into the lower housing part, and an upper housing part placed onto the cover.

It is proposed, according to embodiments of the invention, that the cover is supported in the housing on a guide means and the guide means forms a guide for the cover in the housing, said guide keeping the cover spaced apart from the lower housing part and upper housing part with a radial assembly gap. Further details regarding the turbomachine are described above with respect to the method.

The cover is advantageously supported indirectly or directly on the guide means in the lower housing part. The support takes place expediently both at temperature equality with the housing and also in the event of a temperature difference of more than 100 Kelvin between the cover and housing. In this way, it is possible for the guiding to take place both during assembly and during normal operation by way of the same guide means. It is possible to dispense with further possibly different guide elements during assembly and operation.

The housing expediently engages around the cover from the outside in the axial direction such that it can be pushed or pushes axially outward in a sealing manner against the housing. The cover is in this case expediently held in the housing such that it is impossible to remove the housing without separating the upper housing part from the lower housing part.

As described above, the centered guiding is expediently upheld by the guide both during assembly—that is to say maintaining an assembly gap—and during operation—forming an operating gap. Centered guiding can thus be achieved by the support of the cover in the housing with the aid of the guide element. The mounting and operating gaps are the same gaps. The cover can rest directly on a guide element of the guide means or be supported indirectly in the housing via the guide element, for example via a flow guide vane, in particular an inlet guide vane. The weight of the cover expediently rests completely on the guide means or the guide elements thereof, at least during assembly or in a state of equal temperature. The cover also rests with its entire weight on the guide means or the guide elements thereof during operation or in a state with a temperature difference, although in extreme cases it is possible for the weight to rest directly in the housing when the latter encloses the cover in contact therewith, as can occur in the case of a very large temperature difference.

The guide means is expediently arranged separately from the fitting region of the cover with the housing. As a result, guiding independently of the fitting can take place. Expediently, the guide means is arranged outside the radial assembly gap.

Further expediently, the guide means is arranged inside the housing. As a result, supporting in the housing can take place in a particularly easy manner.

A further advantage is achieved when the cover is fastened to a flow guide vane, in particular an inlet guide vane, and the cover is supported in the housing via the flow guide vane and the guide means. As a result, the cover can be embodied radially in a relatively small manner such that sealing and assembly are rendered easier. The guide means or the guide elements thereof are in this case arranged advantageously radially outside the cover.

With the same advantage, a guide element of the guide means is expediently fastened to a flow guide vane and rests on the lower housing part.

Horizontal guiding can be achieved particularly easily and already during assembly when the guide means has a guide element by way of which the cover—directly or indirectly via a flow guide vane—forms a form fit with the housing, said form fit forming a horizontal guide for the cover, by way of which the cover is mounted in a horizontally guided manner in the housing. This horizontal guide is expediently embodied such that it remains maintained in all temperature cases, that is to say including during operation and not just during assembly.

The horizontal guiding can be achieved easily when the guide element is fastened in the housing, in particular in the lower housing part, and engages in the composite, in particular the cover.

The description given thus far of advantageous configurations of the invention includes numerous features that are reproduced in the individual dependent claims, in some cases combined into groups. However, a person skilled in the art will expediently also consider these features individually and combine them into appropriate further combinations. In particular, these features can each be combined individually and in any suitable combination with the method according to embodiments of the invention and the turbomachine according to embodiments of the invention in accordance with the independent claims.

The characteristics, features and advantages of the invention that are described above and the manner in which they are achieved will be more clearly comprehensible in conjunction with the following description of the exemplary embodiments, which are explained in greater detail in conjunction with the drawings. The exemplary embodiments are used to explain the invention and do not restrict the invention to the combination of features, including functional features, that is specified therein. For this purpose, it is furthermore also possible for suitable features of each exemplary embodiment to be considered explicitly in isolation and combined with any one of the claims.

### BRIEF DESCRIPTION

Some of the embodiments will be described in detail, with reference to the following figures, wherein like designations denote like members, wherein:

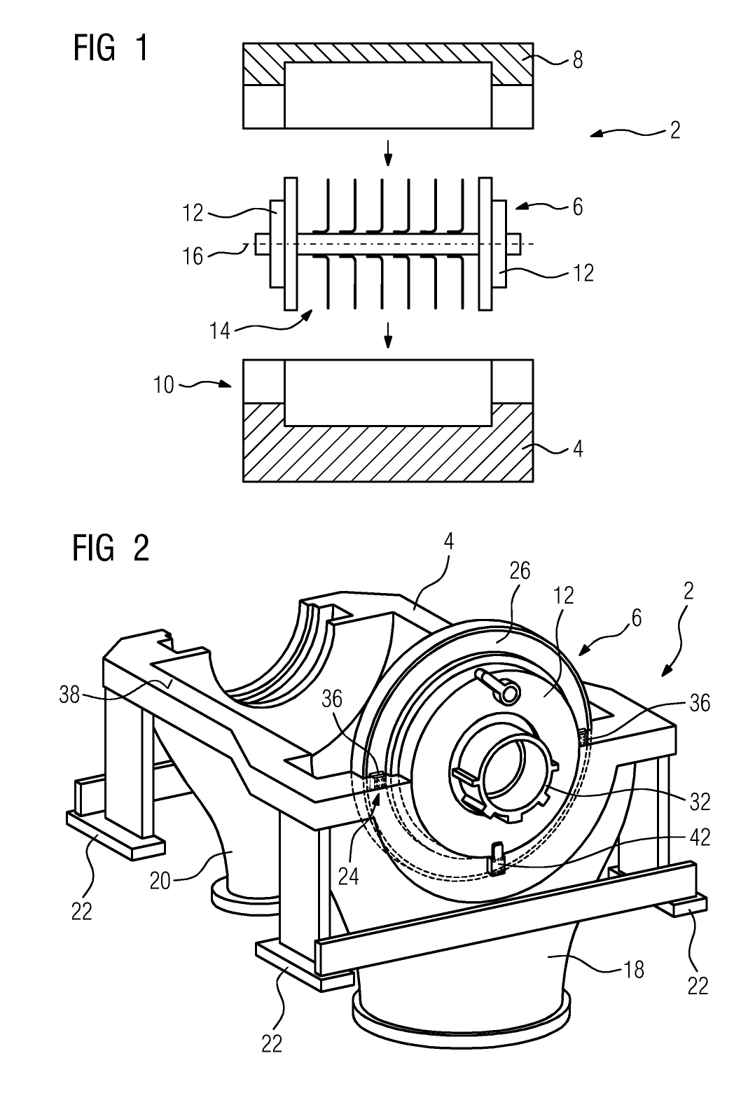

FIG. 1 shows a schematic sectional illustration of an embodiment of a turbomachine;

FIG. 2 shows a lower housing part of an embodiment of the turbomachine with an inserted cover;

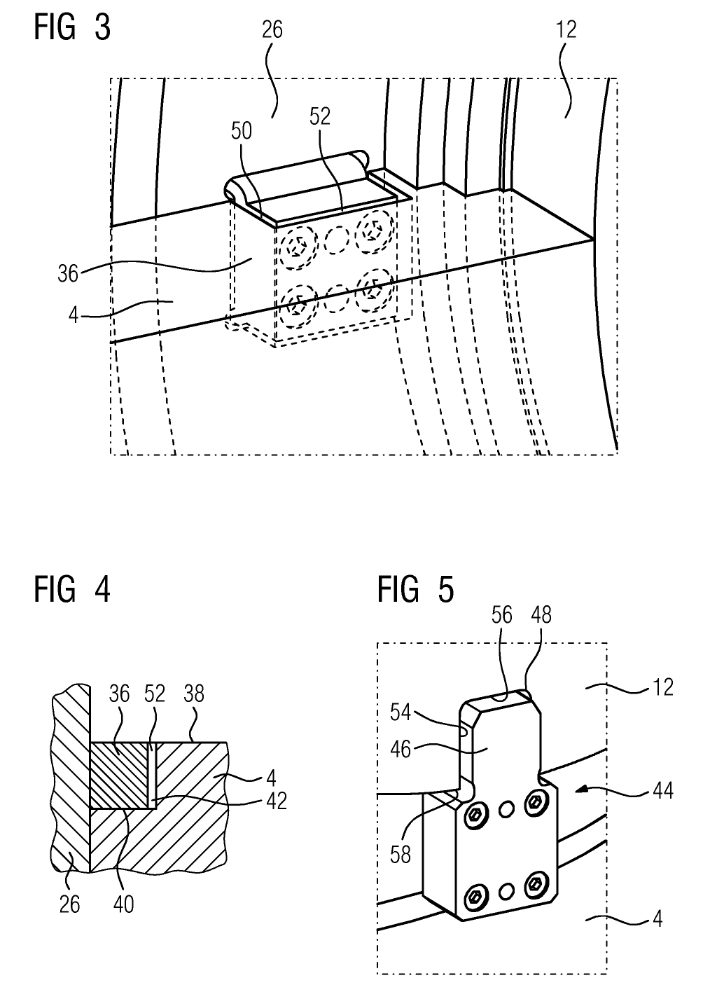

FIG. 3 shows a detail from FIG. 2 with an embodiment of a guide element by way of which the cover is supported on the lower housing part;

FIG. 4 shows a section view through an embodiment of the guide element from FIG. 3;

FIG. 5 shows a further embodiment of a guide means onto which the cover has been plugged; and

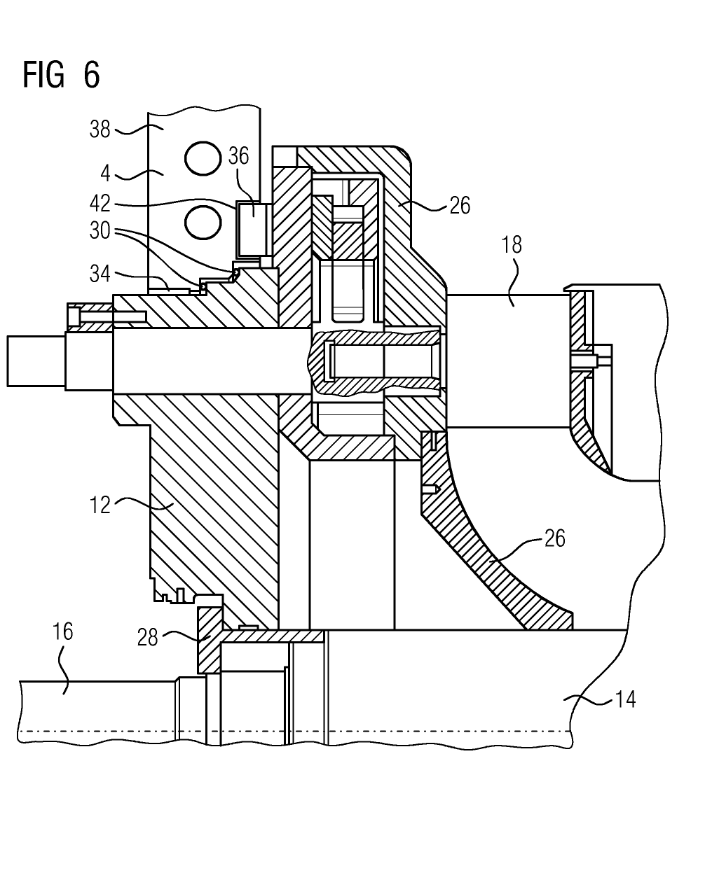

FIG. 6 shows a sectional illustration through a part of the cover and of the lower housing part.

### DETAILED DESCRIPTION

In large turbomachines, the housing is divided into a lower housing part and an upper housing part. In order to assemble the turbomachine, first of all the lower housing part is set up and then a rotor composite is inserted from above into the lower housing part. This is schematically illustrated in FIG. 1. The lower housing part 4 of the turbomachine 2 stands on a solid underlying surface and the composite 6 is lowered from above into the lower housing part 4. Subsequently, the upper housing part 8 is placed onto the lower housing part 4 and screwed together therewith, resulting in the overall housing 10. The composite is surrounded by the housing 10, wherein two covers 12 of the composite 6 remain visible from the outside and can also be designated part of the housing 10. The two covers 12 are in turn connected to the rotor 14, the shaft 16 of which is guided through the two covers 12 and is sealed off in the two covers 12 by way of a shaft seal (not illustrated). The covers 12 and rotor 14 with the shaft 16, and also optionally further components, form the composite 6.

FIG. 2 shows a rough perspective illustration of the lower housing part 4 with one of the two covers 12. In this exemplary embodiment, the turbomachine 2 is a single-shaft radial compressor having a gas inlet 18 and a gas outlet 20. The gas to be compressed flows into the turbomachine 2 through the gas inlet 18, is compressed by the rotation of the rotor 14 and leaves the turbomachine 2 in a compressed and heated state through the gas outlet 20. The lower housing part 4 is secured to the solid underlying surface via supports 22.

FIG. 2 does not show an assembled state of the turbomachine 2 since, for the sake of improved clarity, the cover 12 is illustrated on its own without the rotor 14 and the further opposite cover 12. FIG. 2 would be considered to be complete with the cover 12 shown being placed on the shaft 16 of the rotor 14 and the opposite cover 12 likewise being positioned on the shaft 16. During assembly, the cover 12 is positioned on the shaft 16 via a shipping insert 28 (FIG. 6). This composite 6 is then set down in the lower housing part 4 in the state shown in FIG. 2. The composite 6 is in this case supported in the lower housing part 4 via a guide means 24 which is illustrated in more detail in FIGS. 3 to 5. As a result, the composite 6 and, together therewith, the covers 12 and the rotor 14 are held in a centered manner within the housing 10.

FIG. 6 shows a detail of the cover 12 and the lower housing part 4 in a sectional plan view. Also to be seen are the shaft 16 and an inlet guide vane 26 by way of which the gas to be compressed that flows in through the gas inlet 18 is directed to the rotor 14.

In order to assemble the turbomachine 2 or the turbocompressor, the composite 6 is formed from the two covers 12 and the rotor 14. This composite 6 is lowered into the lower housing part 4 and inserted there. This assembly state is shown in FIG. 6. At this time, the shaft 16 is still held in the two covers 12 by a shipping insert 28, such that the shaft 16 and, together therewith, the entire rotor 15 is positioned in a centered manner in the two covers 12. Subsequently, the upper housing part 8 is placed onto the lower housing part 4 and the two parts 4, 8 are screwed together.

Now, the cover 12 is pulled axially outward via assembly lugs so that it rests against seals 30 that are schematically illustrated in FIG. 6 and is thus sealed with respect to the housing 10. Then, the shaft seals, which seal the shaft 16 with respect to the two covers 12, are fitted. Subsequently, the bearing receptacles 32 (see FIG. 2) and the shaft bearings are fitted such that the shaft 16 is now mounted in the two covers 12. Now, the shaft 16 is secured from the outside and the shipping insert 28—or the two shipping inserts 28 for the two covers 12—is removed. The shaft 16 is in this case held in a centered manner.

When the composite 6 is inserted into the lower housing part 4, care should be taken to ensure that the composite and in particular the shaft 16 is arranged in a centered manner in the housing 10. This cannot be achieved by the composite 6 being inserted with the two covers 12 into the corresponding fitting part of the housing 10 since a radial assembly gap 34 has to remain between the housing 10 and the two covers 12, said radial assembly gap 34 allowing a thermal movement of the housing 10 with respect to the covers 12. This assembly gap 34 also has to be maintained downwardly, so that the two covers 12 cannot be inserted readily into the housing 4.

In order to mount the composite 6 and the two covers 12 centrically in the housing 10, during insertion into the lower housing part 4, the composite 6 is supported in the lower housing part 4 with the aid of the guide means 24—a guide means 24 is provided for each cover. To this end, the guide means 24 comprises two guide elements 36, of which one is illustrated in FIG. 3 and FIG. 4.

The two guide elements 36 are located opposite one another, as is indicated in FIG. 2, at the level of the joint 38, also known as the “horizontal split line”, at which the upper housing part 8 rests on the lower housing part 4 and is screwed thereto. The two guide elements 36 are firmly screwed together at the inlet guide vane 26 and project out of the latter axially toward the front as a formation. By way of their lower bearing surfaces they rest against a bearing surface 40 of the lower housing part 4, said bearing surface 40 being schematically illustrated in FIG. 4.

FIG. 4 shows a schematic section through a guide element 36 at the inlet guide vane 26 and at the lower housing part 4. Incorporated into the lower housing part 4 is a pocket 42, the bottom surface of which is the bearing surface 40. Located in this pocket 42 is the guide element 36. The vertical dimensions of the pocket 42 and of the guide element 36 are in this case measured such that the top edge of the guide element 36 is located at the top edge of the lower housing part 4, that is to say at the level of the joint 38, such that the guide element 36 and the lower housing part terminate flush with one another at the top. As a result of the guide element 36 resting on the bearing surface 40, said guide element 36 supports the inlet guide vane 26 on the lower housing part 4.

One of the guide elements 36 is illustrated from above in FIG. 6. It rests on the bearing surface 40 in the pocket 42 and is fastened to the inlet guide vane 26. The latter is in turn fastened to the cover 12 and projects radially outwardly beyond the cover 12. As a result of this arrangement of the guide element 36 at the inlet guide vane 26, the cover 12 can in principle be kept relatively small radially, since the guide element 36 that is located further out does not have to be fastened directly to the cover 12.

By way of the two guide elements 36, the composite 6 is held in a centered manner in the housing 10 in the vertical direction. The radial assembly gap 34 is in this case ensured above and below the cover 12. Laterally, it can be achieved by exact insertion of the composite 6 in the lower housing part 4. However, this horizontal centering is rendered easier by a further guide element 44 which is illustrated in FIG. 5.

The guide element 44 is screwed axially from the front onto the lower housing part 4 and has a formation 46 which engages in a form-fitting manner in a recess 48 in the cover 12. As a result, horizontal guiding of the cover 12 or of the composite 6 in the lower housing part 4 is achieved, and so the composite 6 and the cover 12 are arranged in the housing 10 in a horizontally centered manner, specifically perpendicularly to an axial direction of the rotor 14. In this way, with the aid of the three guide elements 36, 44, two-dimensional guiding—vertically and laterally—of the cover 12 and of the composite 6 in the housing 10 is achieved. As a result, the assembly gap 34 is achieved with a uniform thickness all the way round the cover 12 or between the cover 12 and the housing 10.

If the upper housing part 8 is lowered from above onto the lower housing part 4, it also surrounds the guide elements 36 of the guide means 24, such that said guide elements are located within the housing 10.

The guide means 24 is designed such that the composite 6 and, together therewith, the cover 12 remains movable with respect to the housing 10 in the axial direction. This is advantageous particularly for the sealing of the cover 12 in the housing 10 since the cover can be pulled axially outwardly against the seal 30. The two guide elements 36 of the guide means 24 slip on the lower housing part 4 in a manner corresponding to this movement. The guide element 44, too, allows an axial movement, since the form fit as a result of the formation 44 in the recess in the cover 12 generates only tangential fixing and allows a vertical-radial and axial movement.

The same also applies for the horizontal-radial movement which is allowed by the two guide elements 36 of the guide means 24. In the event of a thermal movement of the composite 6 with respect to the housing 10, the two guide elements 36 slip radially over the bearing surface 40 of the lower housing part 4. The thermal movement is thus not prevented by the centering fixing.

The guide element 44 is dimensioned in conjunction with the recess 48 such that a tangential gap 54 between the guide element 44 and the recess 48 is narrower than a radial gap 56, 58 between the guide element 44 and the recess 48. In particular, the radial gap 56, 58 is at least twice as wide, more particularly at least 5× as wide, as the tangential gap 54. The greater width ensures that exact horizontal guiding is achieved, whereas a large vertical clearance for temperature movements is allowed.

With regard to the guide element 36, the latter is arranged in the pocket 42 such that a radial gap 50 is provided between the pocket 42 and the guide element 36 on both sides of the guide element 36 and an axial gap 52 is provided in front of the guide element 36. The gaps 50 are wider than the gaps 54, expediently at least twice as wide, in particular at least 5× as wide as the gaps 54. A suitable width of the gaps 50 is between 10 mm and 20 mm. As a result of the wider gaps 50, a radial temperature movement of the cover 12 relative to the lower housing part 4 is allowed. Exact vertical guiding is achieved by the guide element 36 resting on the bearing surface 40. As a result of the separation of functions of the horizontal guide (guide element 36) and vertical guide (guide element 44), exact guiding of the cover 12 and of the rotor 14 in the housing can be achieved even with considerable temperature movements during operation.

As a result of the guide elements 36 slipping on the bearing surface 40, the vertical centering of the composite 6 in the housing 10 is maintained. The horizontal centering is maintained by the guide element 44 even when the latter is moved radially and/or axially by for example a thermal movement relative to the cover 12. In this respect, a radial and axial movement is possible without the centering being disadvantageously influenced thereby.

As a result of the provision of the guide means 24, the centering of the composite 6 and of the cover 12 in the housing 10 is separated spatially from the fitting region of the cover 12 in the housing 10. As a result, the fitting region has no centering function, and so, as a result of this separation of functions, a desired and settable assembly gap 34 is producible. The guide means 24 or the guide elements 36 thereof are to this end arranged radially outside the assembly gap 34 such that the cover 12 is mounted in the lower housing part 4 from the outside.

Although the invention has been described and illustrated in more detail by way of the exemplary embodiments, the invention is not limited by the examples disclosed and other variations can be derived therefrom by a person skilled in the art without departing from the scope of protection of the invention.

1. A method for assembling a turbomachine having a housing and a rotor, wherein at least one cover of the housing is fastened to the rotor, and a composite is inserted into a lower part of the housing and then enclosed by an upper part of the housing, the method comprising:
supporting the composite, during insertion, on at least one guide means in the housing, and the at least one guide means forms a guide for the at least one cover in the housing, wherein the guide keeping the inserted cover spaced apart from the lower housing part and the upper housing part with a radial assembly gap.

2. The method as claimed in claim 1, wherein the composite forms a form fit with a guide element of the at least one guide means during insertion, the form fit forming a vertical and/or horizontal guide by way of which the cover is mounted in a vertically and/or horizontally guided manner in the housing.

3. The method as claimed in claim 1, wherein in the event of thermal shrinkage of the housing relative to the cover, the cover slips in the guide and remains centered with respect to the housing.

4. The method as claimed in claim 1, wherein, for the purpose of sealing, the cover is pulled axially outward in the housing against an axial seal and in the process slips in the guide.

5. A turbomachine comprising: a rotor and a housing which has a lower housing part, at least one cover inserted into the lower housing part, and an upper housing part placed onto the cover, wherein the cover is supported in the housing on a guide means which forms a guide for the cover in the housing, the guide keeping the cover spaced apart from the lower housing part and the upper housing part with a radial assembly gap.

6. The turbomachine as claimed in claim 5, wherein the guide means is arranged outside the radial assembly gap.

7. The turbomachine as claimed in claim 5, wherein the guide means is arranged inside the housing.

8. The turbomachine as claimed in claim 5, wherein the cover is fastened to a flow guide vane, and the cover is supported in the housing via the flow guide vane and the guide means.

9. The turbomachine as claimed in claim 5, wherein a guide element of the guide means is fastened to a flow guide vane and rests on the lower housing part.

10. The turbomachine as claimed in claim 5, wherein the guide means has a guide element by way of which the cover forms a form fit with the housing, the form fit forming a horizontal guide for the cover, by way of which the cover is mounted in a horizontally guided manner in the housing.

11. The turbomachine as claimed in claim 10, wherein the guide element is fastened in the housing and engages in the cover.
